(19) United States
(12) Patent Application Publication
(10) Pub. No.: US 2010/0330415 A1
(43) Pub. Date: Dec. 30, 2010

(54) SECONDARY BATTERY HAVING AN INSULATING CASE LOCATED BETWEEN AN ELECTRODE ASSEMBLY AND A CAP ASSEMBLY

(75) Inventor: Jounghwan PARK, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/751,025

(22) Filed: Mar. 31, 2010

(30) Foreign Application Priority Data
Jun. 29, 2009 (KR) 10-2009-0058362

(51) Int. Cl. H01M 2/02

(52) U.S. Cl. 429/178; 429/163

(57) ABSTRACT

A secondary battery having improved high and low temperature stability includes an insulating case which is prevented from being deformed and damaged at high and low temperatures. The secondary battery includes an electrode assembly, a case accommodating the electrode assembly, a cap assembly coupled with the case, and an insulating case positioned between the electrode assembly and the cap assembly. The heat resistance temperature of the insulating case is about 100° Celsius to about 200° Celsius.

### CROSS-REFERENCE TO RELATED APPLICATION

This application claims priority to and the benefit of Korean Patent Application No. 10-2009-0058362, filed on Jun. 29, 2009, the entire content of which is incorporated herein by reference.

### BACKGROUND OF THE INVENTION

1. Field of the Invention

An aspect of the present invention relates to a secondary battery.

2. Description of the Related Art

In general, unlike a primary battery that cannot be charged, a secondary battery is charged and discharged. The secondary battery is widely employed in a high-technology electronic apparatus such as a cellular phone, a laptop computer, a camcorder, and the like. In particular, the use of a lithium secondary battery is rapidly increasing due to its high energy density per unit weight and driving voltage of 3.6V, which is three times larger than that of a nickel-cadmium battery and a nickel-hydrogen battery which are widely used as a power source of an electronic apparatus.

In the lithium secondary battery, a lithium-based oxide is used as a first electrode active material and a carbon material is used as a second electrode active material. The lithium secondary battery is manufactured to have various shapes such as a cylindrical type shape, a prismatic type shape, and a pouch type shape.

In general, the lithium secondary battery includes an electrode assembly, a can accommodating the electrode assembly, and a cap assembly coupled with the can. The lithium secondary battery can have safety issues such as developing a fire due to external pressure or shock. Therefore, a lithium secondary battery having an improved structure dealing with these safety issues is continuously developed.

### SUMMARY OF THE INVENTION

An aspect of the present invention provides a secondary battery whose high temperature stability and low temperature stability are improved by including an insulating case that is not deformed and damaged under high temperature and low temperature environments.

In accordance with an embodiment of the present invention, a secondary battery includes: an electrode assembly; a case accommodating the electrode assembly; a cap assembly coupled with the case; and an insulating case positioned between the electrode assembly and the cap assembly and having a heat resistance temperature of about 100° Celsius to about 200° Celsius.

According to another aspect of the present invention, the insulating case includes an ethylene propylene diene M-class (EPDM).

According to another aspect of the present invention, the insulating case is made of a terpolymer of ethylene, propylene, and non-conjugated diene.

According to another aspect of the present invention, a ratio of ethylene to propylene is 20:1 to 50:1.

According to another aspect of the present invention, the non-conjugated diene comprises ethylidene norbornene (ENB).

According to another aspect of the present invention, the insulating case includes ethylene propylene diene M-class (EPDM) and further comprises a material selected from the group consisting of polypropylene, polyethylene terephthalate, polyethylene, polyphenylene sulfide, polyether sulfone, polytetrafluoro ethylene, and a combination thereof.

According to another aspect of the present invention, the insulating case includes: a first layer made of a material selected from the group consisting of polypropylene, polyethylene terephthalate, polyethylene, polyphenylene sulfide, polyether sulfone, polytetrafluoro ethylene, and a combination thereof; and a second layer made of the EPDM to surround the first layer.

In accordance with another embodiment of the present invention, a secondary battery includes: an electrode assembly, to which an electrode tab is connected; a case accommodating the electrode assembly; a cap assembly coupled with the case; and an insulating case positioned between the electrode assembly and the cap assembly and including an electrode tab outlet through which the electrode tab passes, wherein, a peripheral region of the electrode tab outlet and a remaining region adjacent to the peripheral region in the insulating case are made of different materials.

According to another aspect of the present invention, the heat resistance temperature of the peripheral region of the electrode tab outlet is of about 100° Celsius to about 200° Celsius.

According to another aspect of the present invention, the peripheral region of the electrode tab outlet comprises ethylene propylene diene M-class (EPDM).

According to another aspect of the present invention, the peripheral region of the electrode tab outlet is made of terpolymer of ethylene, propylene, and non-conjugated diene.

According to another aspect of the present invention, the ratio of ethylene to propylene is 20:1 to 50:1.

According to another aspect of the present invention, the non-conjugated diene comprises ethylidene norbornene (ENB).

According to another aspect of the present invention, the peripheral region of the electrode tab outlet includes ethylene propylene diene M-class (EPDM) material and further includes a material selected from the group consisting of polypropylene, polyethylene terephthalate, polyethylene, polyphenylene sulfide, polyether sulfone, polytetrafluoro ethylene, and a combination thereof.

According to another aspect of the present invention, the remaining region includes a material selected from the group consisting of polypropylene, polyethylene terephthalate, polyethylene, polyphenylene sulfide, polyether sulfone, polytetrafluoro ethylene, a and combination thereof.

According to another aspect of the present invention, the secondary battery includes the insulating case made of the EPDM having high heat resistance and cold resistance placed between the electrode assembly and the cap assembly. Therefore, although the secondary battery may reach a high temperature of about 100° Celsius to about 200° Celsius due to overcharge, the secondary battery may be prevented from being deformed due to the melting of the insulating case. Also, although the secondary battery may reach a low temperature of −50° Celsius due to various factors, the secondary battery may be prevented from being damaged due to the cracking or breaking of the insulating case.

According to another aspect of the present invention, in the secondary battery, damage to the separator and the electrode plate may be prevented due to the deformation of the insulating case at a high temperature, therefore, preventing the generation of an electric short and improving the stability of the secondary battery at a high temperature.

According to another aspect of the present invention, damage to the insulating case at a low temperature may be prevented due to the insulating case not performing a function, thereby maintaining the stability of the secondary battery at the low temperature.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a secondary battery according to an embodiment of the present invention;

FIG. 2 is a sectional view illustrating an assembly of the secondary battery of FIG. 1;

FIG. 3 is an enlarged perspective view of an insulating case of the secondary battery of FIG. 1;

FIG. 4 is a sectional view illustrating an insulating case of a secondary battery according to another embodiment of the present invention, corresponding to the insulating case of FIG. 3;

FIG. 5 is a sectional view illustrating an insulating case of a secondary battery according to still another embodiment of the present invention, corresponding to the insulating case of FIG. 3;

FIG. 6 is an enlarged perspective view illustrating an insulating case of a secondary battery according to still another embodiment of the present invention, corresponding to the insulating case of FIG. 3;

FIG. 7 is a sectional view illustrating the insulating case taken along the line A-A of FIG. 6; and

FIG. 8 is a sectional view illustrating the insulating case a secondary battery according to still another embodiment of the present invention, corresponding to the insulating case of FIG. 7.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, embodiments of the present invention will be described in detail with reference to the accompanying drawings.

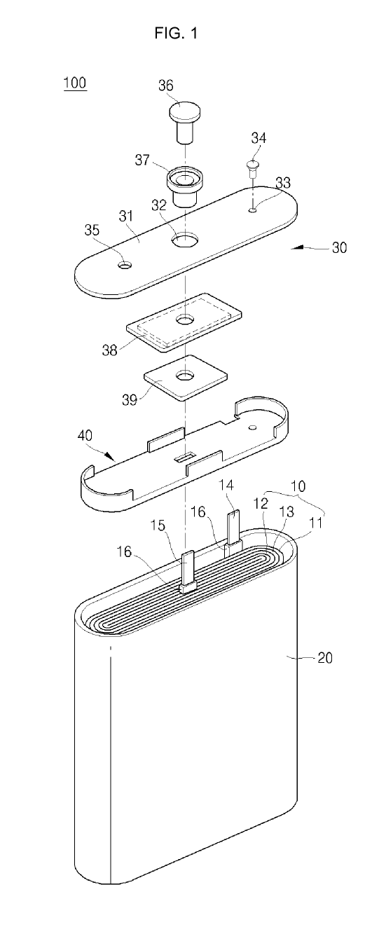

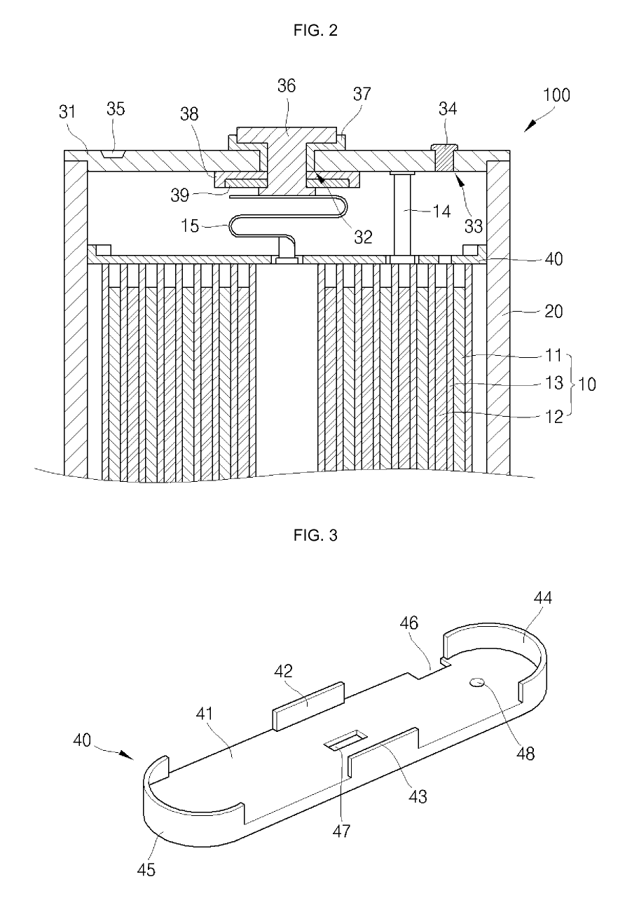

FIG. 1 is an exploded perspective view illustrating a secondary battery according to an embodiment of the present invention. FIG. 2 is a sectional view illustrating an assembly of the secondary battery of FIG. 1. FIG. 3 is an enlarged perspective view illustrating the insulating case of the secondary battery of FIG. 1.

Referring to FIGS. 1 to 3, a secondary battery 100 according to an embodiment of the present invention includes an electrode assembly 10, a case 20 accommodating the electrode assembly 10 and an electrolyte (not shown), and a cap assembly 30 sealing a top opening of the case 20. The secondary battery 100 according to the embodiment of the present invention further includes an insulating case 40 disposed between the electrode assembly 10 and the cap assembly 30.

The electrode assembly 10 is formed by winding a lamination of or overlapping a first electrode plate 11, a separator 13, and a second electrode plate 12 that are thin plates or film-shaped. The electrode assembly 10 includes electrode tabs, that is, a first electrode tab 14 and a second electrode tab 15.

The first electrode plate 11 may include a first electrode collector made of aluminum foil and a first electrode active material formed on the first electrode collector. Cobalt acid lithium may be used as the first electrode active material.

The second electrode plate 12 may include a second electrode collector made of copper foil and a second electrode active material formed on the second electrode collector. Carbon may be used as the second electrode active material.

The first electrode plate 11 may serve as a positive electrode and the second electrode plate 12 may serve as a negative electrode. The first electrode plate 11 may have a polarity different from that of the second electrode plate 12.

The separator 13 may be made of polyethylene, polypropylene, or copolymer of polyethylene and polypropylene. In order to prevent a short between electrode plates it is effective that the width of the separator 13 be larger than the widths of the first electrode plate 11 and the second electrode plate 12.

The first electrode tab 14 and the second electrode tab 15 are extend from the first electrode plate 11 and the second electrode plate 12, respectively. Insulating tapes 16 are wound around boundaries of the first electrode tab 14 and the second electrode tab 15 that are withdrawn to the outside of the electrode assembly 10 to prevent a short between the electrode plates.

The case 20 is a metal can and may be formed by deep drawing. The case 20 is made of aluminum that is a light conductive metal or an aluminum alloy and may serve as an electrode. In the embodiment of the present invention, the case 20 serves as a positive electrode. The case 20 becomes a container accommodating the electrode assembly 10 and the electrolyte. The open top of the case 20 through which the electrode assembly 10 is inserted into is sealed by the cap assembly 30.

The cap assembly 30 may include a cap plate 31, a stopper 34, a safety vent 35, and an electrode terminal 36.

The cap plate 31 may be made of a metal plate having the size and shape corresponding to the size and shape of a top opening of the case 20. The cap plate 31 is coupled with the case by welding to serve as the same electrode as the case 20, that is, the positive electrode. A terminal through-hole 32 may be formed in the center of the cap plate 31. An electrolyte injection hole 33 may be formed on one side of the cap plate 31.

The stopper 34 is provided to seal the electrolyte injection hole 33 after the electrolyte is injected into the case 20 through the electrolyte injection hole 33. The stopper 34 is formed of a ball-shaped material made of aluminum or an aluminum containing metal. The stopper 34 is mechanically press fitted into the electrolyte injection hole 33 to be coupled with the electrolyte injection hole 33.

The safety vent 35 may be formed on the other side of the cap plate 31 to secure the safety of the battery by allowing the release of internal gas when the internal pressure of the case 20 increases due to overcharge. The safety vent 35 is formed to be thinner than the other parts of the cap plate 31 so as to be first broken to allow the release of the internal gas when internal pressure increases.

The electrode terminal 36 passes through the cap plate 31 through the terminal through hole 32. A tube-shaped gasket 37 is installed on the external surface of the electrode terminal 36 to insulate the electrode terminal 36 from the cap plate 31. An insulating plate 38 is installed on the bottom of the cap plate 31, and a terminal plate 39 is installed on the bottom of the insulating plate 38. The bottom of the electrode terminal 36 is electrically connected to the terminal plate 39. The electrode terminal 36 is electrically connected to the second electrode plate 12 of the electrode assembly 10 through the second electrode tab 15 of the electrode assembly 10. On the other hand, the first electrode plate 11 of the electrode assembly 10 is electrically connected to the cap plate 31 through the first electrode tab 14.

The insulating case 40 may include a body 41, supports 42, 43, 44, and 45, electrode tab outlets 46 and 47, and an electrolyte injection hole 48.

The body 41 is made of a plate having the size and the shape to be inserted into the case 20.

The supports 42, 43, 44, and 45 protrude upwardly from the edge of the body 41 by a preset height. The supports 42, 43, 44, and 45 may stably support the body 41 and may improve a coupling force between the insulating case 40 and the inner walls of the case 20 when the insulating case 40 is accommodated in the case 20 to prevent the insulating case 40 from moving. In addition, the supports 42, 43, 44, and 45 may reinforce the strength of the insulating case 40 to prevent the body 41 from being deformed when a physical shock is applied to the secondary battery 100. The supports 42, 43, 44, and 45 may be integrated with the body 41.

The electrode tab outlets 46 and 47 are formed in the body 41 so that the first and second electrode tabs 14 and 15 pass through the body 41.

The electrolyte injection hole 48 is formed in the body 41 so that the electrolyte passes through the body 41 to be introduced into the electrode assembly 10 via the body 41.

The insulating case 40 prevents an electric short between the electrode assembly 10 and the cap assembly 30, supports and fixes the first electrode tab 14 and the second electrode tab 15, and protects the electrode assembly 10.

The insulating case 40 is made of an insulating material having heat resistance temperature of about 100° Celsius. to about 200° Celsius in order to prevent the insulating case 40 from melting and deforming at a high temperature and to prevent the insulating case 40 from not serving as a case. The lowermost limit of the heat resistance temperature of the insulating case 40 is set as 100° Celsius since the internal temperature of the secondary battery 100 at which the insulating case 40 starts to overheat due to the overcharge of the secondary battery 100 is about 100° Celsius. The uppermost limit of the insulating case 40 is set as 200° Celsius since the other components including the separator in the secondary battery 100 are previously melted so that the secondary battery 100 does not operate when the internal temperature of the secondary battery 100 is higher than 200° Celsius. That is, it is meaningless to prevent the insulating case 40 from being deformed when the internal temperature of the secondary battery 100 is higher than 200° Celsius.

For example, an ethylene propylene diene M-class (EPDM) that is made of terpolymer of ethylene, propylene, and non-conjugated diene is used as the insulating material having the heat resistance temperature of about 100° Celsius to about 200° Celsius. The EPDM has cold resistance against temperatures of no more than −50° Celsius as well as heat resistance against high temperature. Therefore, the insulating case 40 made of the EPDM is not broken but has stability to external environments although the temperature is no more than −50° Celsius. In the EPDM, the ratio of the amount of ethylene to the amount of polypropylene may be 20:1 to 50:1. This is because, when the ratio of the amount of ethylene to the amount of polypropylene is 20:1 to 50:1 in the EPDM, glass transition temperature Tg is about −50° Celsius to about −65° Celsius, the crystallinity, tensile strength, hardness, elasticity, and filler loading of the EPDM increase, and palletizing may be easily performed. In addition, in the EPDM, the non-conjugated diene may be, for example, ethylidene norbornene (ENB). The ENB is used for providing a sulfur crosslink. When the amount of the ENB increases, a cure rate, a cure state, a modulus, hardness, and elasticity increase.

As described above, the secondary battery 100 according to the embodiment of the present invention includes the insulating case 40 made of the EPDM having high heat resistance and cold resistance, and the insulating case 40 is placed between the electrode assembly 10 and the cap assembly 30. Therefore, although the secondary battery 100 may reach a high temperature of about 100° Celsius to about 200° Celsius due to the overcharge of the secondary battery 100, the melting and deformation of the insulating case 40 may be prevented. Also, although the secondary battery 100 may reach a low temperature of −50° Celsius due to various factors, the breakage and damage of the insulating case 40 may be prevented.

Therefore, in the secondary battery 100 according to the embodiment of the present invention, the separator 13 and the electrode plates 11 and 12 are prevented from being damaged due to the deformation of the insulating case 40 at a high temperature preventing an electric short and improving the stability of the secondary battery 100 at high temperature.

In the secondary battery 100 according to the embodiment of the present invention, the insulating case 40 is prevented from not serving as an insulating case when the insulating case is damaged at low temperature.

A secondary battery according to another embodiment of the present invention will be described.

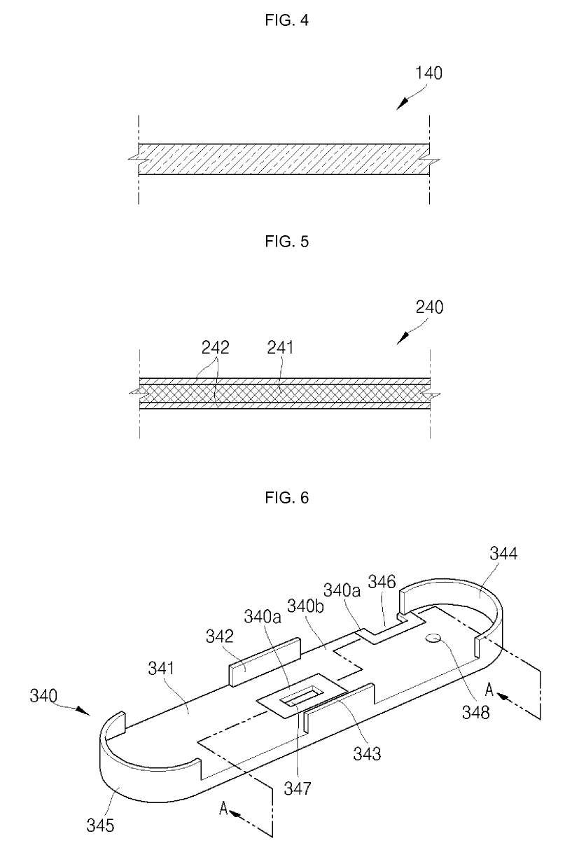

FIG. 4 is a sectional view illustrating an insulating case of a secondary battery according to another embodiment of the present invention, corresponding to the insulating case of FIG. 3.

The secondary battery according to another embodiment of the present invention has the same components as the secondary battery 100 illustrated in FIGS. 1 to 3 except that an insulating case 140 includes the EPDM and other materials. Therefore, in another embodiment of the present invention, only the insulating case 140 is different from the insulating case 40 of FIG. 3 and will be described below.

Referring to FIG. 4, the insulating case 140, like the insulating case 40 of FIG. 3, is made of a material having a heat resistance temperature of about 100° Celsius to about 200° Celsius containing, for example, the EPDM and further containing a material selected from the group consisting of polypropylene (PP), polyethylene terephthalate (PET), polyethylene (PE), polyphenylene sulfide (PPS), polyether sulfone (PES), and polytetrafluoro ethylene (PTFE).

When the insulating case 140 includes the EPDM and the PP, the heat resistance of the insulating case 140 may increase due to the characteristics of the EPDM, and the formability, surface gloss, and shock resistance of the insulating case 140 may increase due to the characteristics of the PP.

When the insulating case 140 includes the EPDM and the PET, the heat resistance of the insulating case 140 increases due to the characteristics of the EPDM, and the tensile strength of the insulating case 140 may increase due to the characteristics of the PET.

When the insulating case 140 includes the EPDM and the PE, the heat resistance of the insulating case 140 increases due to the characteristics of the EPDM, and the tensile strength, chemical resistance, and water resistance of the insulating case 140 may increase due to the characteristics of the PE.

When the insulating case 140 includes the EPDM and the PPS, the heat resistance of the insulating case 140 increases due to the characteristics of the EPDM, and the formability and chemical resistance of the insulating case 140 may increase due to the characteristics of the PPS.

When the insulating case 140 includes the EPDM and the PES, the heat resistance of the insulating case 140 increases due to the characteristics of the EPDM, and the tensile strength, chemical resistance, creep resistance, and tensile strength of the insulating case 140 may increase due to the characteristics of the PES.

When the insulating case 140 includes the EPDM and the PTFE, the heat resistance of the insulating case 140 increases due to the characteristics of the EPDM, and the chemical resistance and abrasion resistance of the insulating case 140 may increase due to the characteristics of the PTFE.

Although, in another embodiment of the present invention, it is described that the insulating case 140 includes the EPDM and further a material selected from the group consisting of PP, PET, PE, PPS, PES, and PTFE, the insulating case 140 includes the EPDM and may further include at least two materials selected from the group consisting of PP, PET, PE, PPS, PES, and PTFE.

As described above, the secondary battery according to another embodiment of the present invention includes the insulating case 140 including the EPDM and further a material selected from the group consisting of PP, PET, PE, PPS, PES, PTFE, and a combination thereof so that it is possible to create an insulating case having various characteristics and to improve the various performances of the secondary battery.

Then, a secondary battery according to still another embodiment of the present invention will be described.

FIG. 5 is a sectional view illustrating an insulating case of a secondary battery according to still another embodiment of the present invention, corresponding to the insulating case of FIG. 3.

The secondary battery according to still another embodiment of the present invention has the same components as the secondary battery 100 illustrated in FIGS. 1 to 3 except that an insulating case 240 includes a first layer 241 and a second layer 242. Therefore, in still another embodiment of the present invention, only the insulating case 240 is different from the insulating case 40 illustrated in FIG. 3 and will be described below.

Referring to FIG. 5, the insulating case 240 may include a first layer 241 that forms the internal layer of the insulating case 240 and a second layer 242 formed to surround the first layer 241 to form the external layer of the insulating case 240.

The first layer 241 is made of a material selected from the group consisting of PP, PET, PE, PPS, PES, PTFE, and a combination thereof.

Since the second layer 241 is directly affected by the temperature of the secondary battery, the second layer 241 is made of the EPDM having high heat resistance and cold resistance. A large amount of the EPDM is not required since the EPDM is formed on the surface of the first layer 241 to a small thickness.

As described above, the secondary battery according to still another embodiment of the present invention includes the insulating case 240 including the first layer 241 and the second layer 242 so that the amount of the high-priced EPDM may be reduced. Therefore, the stability of the secondary battery according to still another embodiment of the present invention may be improved while reducing the fabrication cost of the secondary battery.

Then, a secondary battery according to still another embodiment of the present invention will be described.

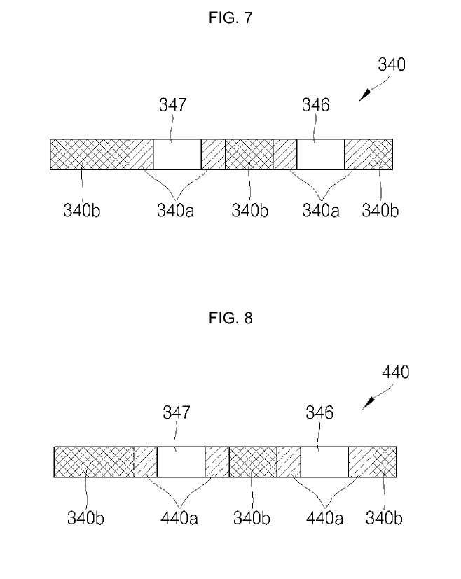

FIG. 6 is an enlarged perspective view illustrating an insulating case of a secondary battery according to still another embodiment of the present invention, corresponding to the insulating case of FIG. 3. FIG. 7 is a sectional view illustrating the insulating case taken along the line A-A of FIG. 6.

The secondary battery according to still another embodiment of the present invention has the same components as the secondary battery 100 illustrated in FIGS. 1 to 3 except that peripheral regions 340a of electrode tab outlets 346 and 347 in the insulating case 340 are made of the EPDM. Therefore, in still another embodiment of the present invention, only the insulating case 340 is different from the insulating case 40 illustrated in FIG. 3 and will be described below.

Referring to FIGS. 6 and 7, the insulating case 340 may include a body 341, supports 342, 343, 344, and 345, electrode tab outlets 346 and 347, and an electrolyte injection hole 348. Since the detailed structure of the insulating case 340 is the same as the detailed structure of the insulating case 40 illustrated in FIG. 3, description thereof will be omitted.

In the insulating case 340, the peripheral regions 340a of the electrode tab outlets 346 and 347 are made of an insulating material having heat resistance temperature of about 100° Celsius to about 200° Celsius, such as, EPDM. This is due to the fact that the peripheral regions 340a of the electrode tab outlets 346 and 347 are positioned near the first and second electrode tabs 14 and 15 and are most significantly affected by the heat of the first and second electrode tabs 14 and 15. Therefore, it is necessary to prevent at least the peripheral regions 340a of the electrode tab outlets 346 and 347 in the insulating case 340 from being deformed due to melting of these regions. On the other hand, since the remaining region 340b excluding the peripheral regions 340a of the electrode tab outlets 346 and 347 in the insulating case 340 is less affected by the heat of the first and second electrode tabs 14 and 15, the remaining region 340b may be of a material selected from the group consisting of PP, PET, PE, PPS, PES, PTFE, and a combination thereof. Since EPDM, PP, PET, PE, PPS, PES, and PTFE were previously described in detail, a detailed description of these elements will be omitted.

As described above, the secondary battery according to still another embodiment of the present invention includes the insulating case 340 in which only the peripheral regions 340a of the electrode tab outlets 346 and 347 are made of the EPDM material so that the amount of the high-priced EPDM may be reduced. Therefore, the safety and the stability of the secondary battery according to still another embodiment of the present invention may be improved while reducing fabrication cost of the secondary battery.

Then, a secondary battery according to still another embodiment of the present invention will be described.

FIG. 8 is a sectional view illustrating the insulating case a secondary battery according to still another embodiment of the present invention, corresponding to the insulating case of FIG. 7.

The secondary battery according to still another embodiment of the present invention has the same components as those of the secondary battery 100 illustrated in FIGS. 1 to 3 except that peripheral regions 440a of the electrode tab outlets 346 and 347 in the insulating case 440 are made of the EPDM and other materials. Therefore, according to still another embodiment of the present invention, only the insulating case 440 is different from the insulating case 40 illustrated in FIG. 3 and will be described below.

Since the detailed structure of the insulating case 440 is the same as the detailed structure of the insulating case 340 illustrated in FIG. 6, a description of the insulating case 440 will be omitted.

In the insulating case 440, referring to FIG. 8, the peripheral regions 440a of the electrode tab outlets 346 and 347 are made of an insulating material having a heat resistance temperature of about 100° Celsius to about 200° Celsius, such as, the EPDM and a material selected from the group consisting of PP, PET, PE, PPS, PES, PTFE, and a combination thereof. On the other hand, since the remaining regions 340b excluding the peripheral regions 440a of the electrode tab outlets 346 and 347 in the insulating case 440 is less affected by the heat of the first and second electrode tabs 14 and 15, the remaining regions 340b may be made of a material selected from the group consisting of PP, PET, PE, PPS, PES, PTFE, and a combination thereof.

As described above, the secondary battery according to still another embodiment of the present invention includes the insulating case 440 having the EPDM and other insulating materials only in the peripheral regions 440a of the electrode tab outlets 346 and 347. Accordingly, the peripheral regions 440a of the electrode tab outlets 346 and 347 may have various characteristics and the amount of the high-priced EPDM may be reduced. Therefore, the safety and the stability of the secondary battery according to still another embodiment of the present invention may be improved while reducing the fabrication cost of the secondary battery and improving the performance of the secondary battery.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A secondary battery, comprising:
an electrode assembly;
a case accommodating the electrode assembly;
a cap assembly coupled with the case; and
an insulating case positioned between the electrode assembly and the cap assembly and having a heat resistance temperature of about 100° Celsius to about 200° Celsius.

2. The secondary battery of claim 1, wherein the insulating case comprises an ethylene propylene diene M-class (EPDM).

3. The secondary battery of claim 1, wherein the insulating case is made of a terpolymer of ethylene, propylene, and non-conjugated diene.

4. The secondary battery of claim 3, wherein a ratio of the ethylene to the propylene is 20:1 to 50:1.

5. The secondary battery of claim 3, wherein the non-conjugated diene comprises ethylidene norbornene (ENB).

6. The secondary battery of claim 1, wherein the insulating case comprises ethylene propylene diene M-class (EPDM) and further comprises a material selected from the group consisting of polypropylene, polyethylene terephthalate, polyethylene, polyphenylene sulfide, polyether sulfone, polytetrafluoro ethylene, and a combination thereof.

7. The secondary battery of claim 1, wherein the insulating case comprises:
a first layer made of a material selected from the group consisting of polypropylene, polyethylene terephthalate, polyethylene, polyphenylene sulfide, polyether sulfone, polytetrafluoro ethylene, and a combination thereof; and
a second layer made of the EPDM to surround the first layer.

8. A secondary battery, comprising:
an electrode assembly, to which an electrode tab is connected;
a case accommodating the electrode assembly;
a cap assembly coupled with the case; and
an insulating case positioned between the electrode assembly and the cap assembly and including an electrode tab outlet through which the electrode tab passes,
wherein, a peripheral region of the electrode tab outlet and a remaining region adjacent to the peripheral region in the insulating case is made of a different material.

9. The secondary battery of claim 8, wherein a heat resistance temperature of the peripheral region of the electrode tab outlet is about 100° Celsius to about 200° Celsius.

10. The secondary battery of claim 8, wherein the peripheral region of the electrode tab outlet comprise ethylene propylene diene M-class (EPDM).

11. The secondary battery of claim 8, wherein the peripheral region of the electrode tab outlet is made of terpolymer of ethylene, propylene, and non-conjugated diene.

12. The secondary battery of claim 11, wherein a ratio of ethylene to propylene is 20:1 to 50:1.

13. The secondary battery of claim 11, wherein the non-conjugated diene comprises ethylidene norbornene (ENB).

14. The secondary battery of claim 8, wherein the peripheral region of the electrode tab outlet comprises ethylene propylene diene M-class (EPDM) material and further comprises a material selected from the group consisting of polypropylene, polyethylene terephthalate, polyethylene, polyphenylene sulfide, polyether sulfone, polytetrafluoro ethylene, and a combination thereof.

15. The secondary battery of claim 8, wherein the remaining region comprises a material selected from the group consisting of polypropylene, polyethylene terephthalate, polyethylene, polyphenylene sulfide, polytetrafluoro ethylene, polyether sulfone, and a combination thereof.
